(19) United States
(12) Patent Application Publication
(10) Pub. No.: US 2023/0097986 A1
(43) Pub. Date: Mar. 30, 2023

(54) DATA PROCESSING METHOD

(71) Applicant: BEIJING BAIDU NETCOM SCIENCE TECHNOLOGY CO., LTD., BEIJING (CN)

(72) Inventors: Han LIU, Beijing (CN); Teng HU, Beijing (CN); Yongfeng CHEN, Beijing (CN)

(21) Appl. No.: 18/058,640

(22) Filed: Nov. 23, 2022

(30) Foreign Application Priority Data
Nov. 26, 2021 (CN) 202111421912.2

(51) Int. Cl. G06F 40/279; G06F 40/30

(52) U.S. Cl. CPC G06F 40/279; G06F 40/30

(57) ABSTRACT

A data processing method is provided. The method includes: determining fusion information based on a text to be processed and a plurality of reference text fragments; executing the following matching operation for each of the plurality of reference text fragments: determining a first coefficient of each feature vector of the fusion information respectively; determining a second coefficient of each feature vector of the fusion information respectively; determining a result feature vector of the reference text fragment using each feature vector included in the fusion information and a weight of the feature vector; and determining a matching degree of the reference text fragment and the text to be processed based on the result feature vector.

### CROSS-REFERENCE TO RELATED APPLICATION

This application claims priority to Chinese patent application No. 202111421912.2, filed on Nov. 26, 2021, the contents of which are hereby incorporated by reference in their entirety for all purposes.

### TECHNICAL FIELD

The present disclosure relates to the technical field of artificial intelligence, especially, the field of natural language processing, in particular to a method and apparatus for data processing, an electronic device, a computer-readable storage medium and a computer program product.

### BACKGROUND

Artificial intelligence is a discipline aimed at studying to make a computer simulate certain human thinking processes and intelligent behaviors (for example, learning, reasoning, thinking, planning and the like), which has both a hardware level technology and a software level technology. The artificial intelligence hardware technology generally includes technologies such as a sensor, a special-purpose artificial intelligence chip, cloud computing, distributed storage and big data processing. The artificial intelligence software technology mainly includes several main directions of a computer vision technology, a voice recognition technology, a natural language processing technology, machine learning/deep learning, big data processing technology, knowledge mapping technology and the like.

A method described in this part is not necessarily a method envisaged or adopted before. Unless otherwise indicated, it should not be presumed that any of methods described in this part is regarded as the prior art only depending on being included in this part. Likewise, unless otherwise indicated, the problem mentioned in this part should not be constructed as being recognized in any prior art.

### SUMMARY

The present disclosure provides a method and apparatus for data processing, an electronic device, a computer-readable storage medium and a computer program product.

According to an aspect of the present disclosure, a method for data processing is provided and includes: determining fusion information based on a text to be processed and a plurality of reference text fragments, wherein the fusion information includes a feature vector of each character in the text to be processed, a feature vector of each character in each reference text fragment and a feature vector of an identifier of each reference text fragment; and executing a matching operation for each of the plurality of reference text fragments, wherein the matching operation includes: determining a first coefficient of each feature vector included in the fusion information respectively based on the similarity between a feature vector of an identifier of that reference text fragment and each feature vector included in the fusion information; determining a second coefficient of each feature vector included in the fusion information respectively based on the correlation between each feature vector included in the fusion information and one or more remaining text fragments other than that reference text fragment of the plurality of reference text fragments; determining a result feature vector of that reference text fragment based on each feature vector included in the fusion information and a weight corresponding to the each feature vector, wherein the weight corresponding to each feature vector is determined based on the first coefficient and the second coefficient of corresponding feature vector; and determining a matching degree of that reference text fragment and the text to be processed based on the result feature vector.

According to an aspect of the present disclosure, an electronic device is provided and includes: one or more processors; and a memory storing one or more programs configured to be executed by the one or more processors, the one or more programs comprising instructions for performing operations comprising: determining a fusion information based on a text to be processed and a plurality of reference text fragments, wherein the fusion information comprises a feature vector of each character of the text to be processed, a feature vector of each character of each reference text fragment of the plurality of reference text fragments and a feature vector of an identifier of the each reference text fragment; and executing a matching operation for the each reference text fragment, wherein the matching operation comprises: determining a first coefficient of each feature vector of the fusion information respectively based on a similarity between the feature vector of the identifier of that reference text fragment and the each feature vector of the fusion information; determining a second coefficient of each feature vector of the fusion information respectively based on a correlation between the each feature vector of the fusion information and one or more remaining text fragments other than that reference text fragment of the plurality of reference text fragments; determining a result feature vector of that reference text fragment based on the each feature vector of the fusion information and a weight corresponding to the each feature vector, wherein the weight corresponding to the each feature vector is determined based on the first coefficient and the second coefficient of corresponding feature vector; and determining a matching degree of that reference text fragment and the text to be processed based on the result feature vector.

According to an aspect of the present disclosure, a non-transitory computer-readable storage medium is provided. The non-transitory computer readable storage medium storing one or more programs comprising instructions that, when executed by one or more processors of an electronic device, cause the electronic device to perform operations comprising: determining a fusion information based on a text to be processed and a plurality of reference text fragments, wherein the fusion information comprises a feature vector of each character of the text to be processed, a feature vector of each character of each reference text fragment of the plurality of reference text fragments and a feature vector of an identifier of the each reference text fragment; and executing a matching operation for the each reference text fragment, wherein the matching operation comprises: determining a first coefficient of each feature vector of the fusion information respectively based on a similarity between the feature vector of the identifier of that reference text fragment and the each feature vector of the fusion information; determining a second coefficient of each feature vector of the fusion information respectively based on a correlation between the each feature vector of the fusion information and one or more remaining text fragments other than that reference text fragment of the plurality of reference text fragments; determining a result feature vector of that reference text fragment based on the each feature vector of the fusion information and a weight corresponding to the each feature vector, wherein the weight corresponding to the each feature vector is determined based on the first coefficient and the second coefficient of corresponding feature vector; and determining a matching degree of that reference text fragment and the text to be processed based on the result feature vector.

It should be understood that described contents in this part are neither intended to indicate key or important features of the embodiments of the present disclosure, nor used to limit the scope of the present disclosure. Other features of the present disclosure will become easier to understand through the following specification.

### BRIEF DESCRIPTION OF THE DRAWINGS

Accompanying drawings, which constitute a part of the specification, exemplarily illustrate embodiments and, together with text description of the specification, serve to explain example implementations of the embodiments. The illustrated embodiments are only intended to serve as examples without limiting the scope of the claims. In all the drawings, the same reference numbers represent similar but not necessarily the same elements.

FIG. 1 shows a schematic diagram of an example system where various methods described herein can be implemented according to an embodiment of the present disclosure.

FIG. 2A and FIG. 2B show a flowchart of a method for data processing according to an embodiment of the present disclosure.

FIG. 3 shows a schematic diagram of a method for determining fusion information according to an embodiment of the present disclosure.

FIG. 4 shows a structural block diagram of an apparatus for data processing according to an embodiment of the present disclosure.

FIG. 5 shows a structural block diagram of an example electronic device capable of being used for implementing embodiments of the present disclosure.

### DETAILED DESCRIPTION

Example embodiments of the present disclosure are described below with reference to the drawings, which include various details of the embodiments of the present disclosure for better understanding and should be regarded as only example. Therefore, those ordinarily skilled in the art should realize that various changes and modifications can be made to embodiments described herein without departing from the scope of the present disclosure. Similarly, for the sake of being clear and concise, description of known functions and structures are omitted in the following description.

In the present disclosure, unless otherwise stated, terms such as “first” and “second” used for describing various elements are not intended to limit a position correlation, a timing sequence correlation or a significance correlation of these elements and are only used for distinguishing one component from another component. In some examples, a first element and a second element may refer to the same instance of the element, which, in some cases, may also refer to different instances on the basis of description of the context.

Terms used in description of various examples in the present disclosure are only intended to describe specific examples but not intended to make a limitation. Unless otherwise indicated clearly in the context, if a quantity of elements is not limited in particular, there may be one or a plurality of the elements. Besides, a term “and/or” used in the present disclosure covers any one or all possible combinations in listed items.

A reference text fragment matching mode is usually adopted for implementation to understand a text by a machine, in the related art, that is, a text to be processed is matched with a plurality of preset reference text fragments respectively, and a content of the text to be processed is understood based on a reference text fragment with a higher matching degree. However, this type of matching mode depends on one-to-one matching of the text to be processed and the reference text fragments and is used to obtain a matching degree of each reference text fragment and the text to be processed, which result in a low efficiency. Under the condition of limited time resources, the quantity of reference text fragments executable for matching is restricted, which results in rough understanding of the text.

The present disclosure provides a data processing method for implementing synchronous processing between the text to be processed and the plurality of reference text fragments. For each of the plurality of reference text fragments, a first coefficient of each feature vector is determined respectively based on the similarity between a feature vector of an identifier of the reference text fragment and each feature vector included in the fusion information; based on this, a second coefficient of each feature vector is determined respectively based on the correlation between each feature vector and other reference text fragments of the plurality of reference text fragments except the reference text fragment; a weight of the feature vector is determined by using the first coefficient and the second coefficient of each feature vector; a result feature vector of the reference text fragment is determined by using each feature vector included in the fusion information and the weight of the feature vector; and finally, a matching degree of the reference text fragment and the text to be processed is determined through the result feature vector.

In processing each reference text fragment in the present disclosure, apart from considering the similarity between the feature vectors in the fusion information, an influence degree on the result feature vector of the reference text fragment by the feature vectors from the other reference text fragments in the fusion information is regulated through the second coefficient, so in a process of executing matching of the text to be processed and the plurality of reference text fragments at the same time, each reference text fragment can obtain targeted processing, so that effective matching between the text to be processed and the plurality of reference text fragments can be executed at the same time, thereby improving the efficiency of data processing.

The embodiments of the present disclosure will be described in detail below with reference to the accompanying drawings.

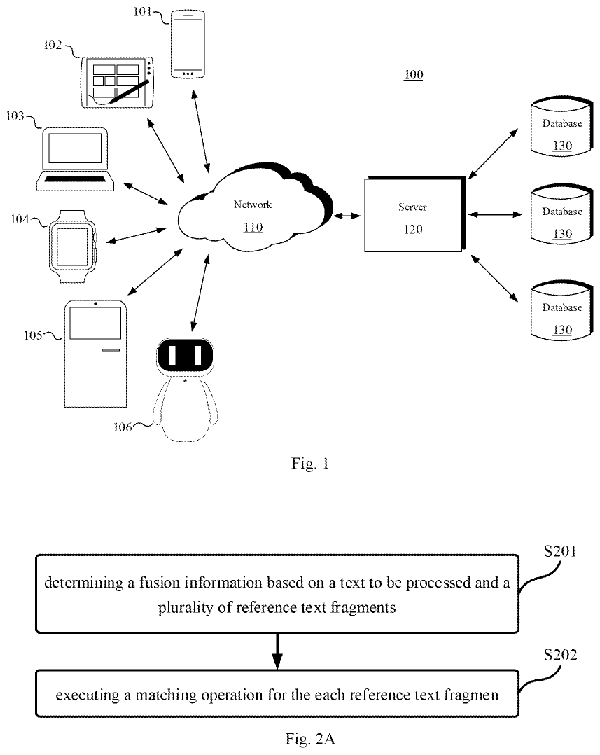

FIG. 1 shows a schematic diagram of an example system 100 where various methods and apparatuses described herein can be implemented according to an embodiment of the present disclosure. Referring to FIG. 1, the system 100 includes one or a plurality of client devices 101, 102, 103, 104, 105 and 106, a server 120 and one or a plurality of communication networks 110 which make the one or the plurality of client devices be coupled to the server 120. The client devices 101, 102, 103, 104, 105 and 106 may be configured to execute one or a plurality of application programs.

In the embodiment of the present disclosure, the server 120 can run one or a plurality of services or software applications capable of executing the method for data processing.

In some embodiments, the server 120 may also provide other services or software applications which may include a non-virtual environment and a virtual environment. In some embodiments, these services can be provided as a web-based service or cloud service, for example, provided to a user of the client devices 101, 102, 103, 104, 105 and/or 106 under software, namely a service (SaaS) model.

In configuration shown in FIG. 1, the server 120 may include one or a plurality of components which implements functions executed by the server 120. These components may include a software component, a hardware component or their combination capable of being executed by one or a plurality of processors. The user who operates the client devices 101, 102, 103, 104, 105 and/or 106 may interact with the server 120 by sequentially utilizing one or a plurality of client application programs so as to utilize services provided by these components. It should be understood that various different system configurations are possible and may be different from the system 100. Therefore, FIG. 1 is an example of a system configured to implement various methods described herein, which is not intended to make a limitation.

The user can obtain the text to be processed by using the client devices 101, 102, 103, 104, 105 and/or 106. The client device can provide an interface which enables the user of the client device to interact with the client device. The client device can also output information to the user via the interface. Though FIG. 1 describes only six types of client devices, those skilled in the art can understand that the present disclosure can support any quantity of client devices.

The client devices 101, 102, 103, 104, 105 and/or 106 may include various computer devices, for example, a portable hand-held device, a general-purpose computer (such as a personal computer and a laptop computer), a workstation computer, a wearable device, a smart screen device, a self-service terminal device, a service robot, a game system, a thin client, various messaging devices, a sensor or other sensing devices and the like. These computer devices can run software application programs and operation systems of various types and versions, for example, MICROSOFT Windows, APPLE iOS, a UNIX-like operation system, Linux or a Linux-like operation system (for example, GOOGLE Chrome OS); or include various mobile operation systems, for example, MICROSOFT Windows Mobile OS, iOS, Windows Phone, and Android. The portable hand-held device may include a cell phone, a smartphone, a tablet PC, a personal digital assistant (PDA), etc. The wearable device may include a head-mounted display (such as smart glasses) and other devices. The game system may include various hand-held game devices, game devices supporting the Internet, etc. The client device can execute various application programs, for example, various application programs related to the Internet, communication application programs (for example, an e-mail application program) and short message service (SMS) application programs and can use various communication protocols.

The network 110 may be any type of network well known to those killed in the art and can use any one type of various available protocols (including but not limited to TCP/IP, SNA, IPX, etc.) to support data communication. Only serving as an example, one or more networks 110 may be a local area network (LAN), a network based on Ethernet, a Token ring, a wide area network (WAN), Internet, a virtual network, a virtual private network (VPN), an intranet, an extranet, a public switched telephone network (PSTN), an Infrared network, a wireless network (for example, Bluetooth and WIFI) and/or any combination of these networks and/or other networks.

The server 120 may include one or more general-purpose computers, special-purpose server computers (for example, a personal computer (PC) server, a UNIX server and a mid-range server), a blade server, a mainframe computer, a server cluster or any of other appropriate layouts and/or combinations. The server 120 may include one or more virtual machines which run a virtual operation system, or involve other virtualized computing architectures (for example, one or more flexible pools of a logical storage device of a virtual storage device capable of being virtualized to maintain the server). In various embodiments, the server 120 can run one or more services or software applications providing functions described below.

A computing unit in the server 120 can run one or more operation systems including any of above operation systems and any of commercially applicable server operation systems. The server 120 can also run any one of various additional server application programs and/or middle-layer application programs, including an HTTP server, an FTP server, a CGI server, a JAVA server, a database server, etc.

In some implementations, the server 120 may include one or more application programs so as to analyze and merge data feed and/or incident updating received from the user of the client devices 101, 102, 103, 104, 105 and/or 106. The server 120 may also include one or more application programs so as to display data feed and/or real-time incidents via one or more display devices of the client device 101, 102, 103, 104, 105 and/or 106.

In some implementations, the server 120 may be a server of a distributed system, or a server combined with a blockchain. The server 120 may also be a cloud server, or an intelligent cloud computing server or an intelligent cloud host with an artificial intelligence technology. The cloud server is a host product in a cloud computing service system so as to overcome defects of high management difficulty and weak business expansibility in services of a traditional physical host and the Virtual Private Server (VPS).

The system 100 may also include one or more databases 130. In some embodiments, these databases may be used for storing data and other information. For example, one or more databases 130 may be used for storing information such as audio files and video files. The databases 130 may reside in various positions. For example, the database used by the server 120 may be in the local of the server 120, or may be away from the server 120 and can communicate with the server 120 via a network or a special-purpose connection. The database 130 may be different types. In some embodiments, the database used by the server 120 may be, for example, a relational database. One or a plurality of these databases can store, update and retrieve data to and from the database in response to a command.

In some embodiments, one or more databases 130 may also be used by an application program to store data of the application program. The database used by the application program may be databases of different types, for example, a key-value storage base, an object storage base or a conventional storage base supported by a file system.

The system 100 in FIG. 1 may be configured and operated in various forms so as to apply various methods and apparatuses described according to the present disclosure.

In the technical solution of the present disclosure, collection, saving, application, processing, transmission, providing, revealing and other processing of involved user personal information conform to regulations of relevant laws and regulations and do not violate public order and good morals.

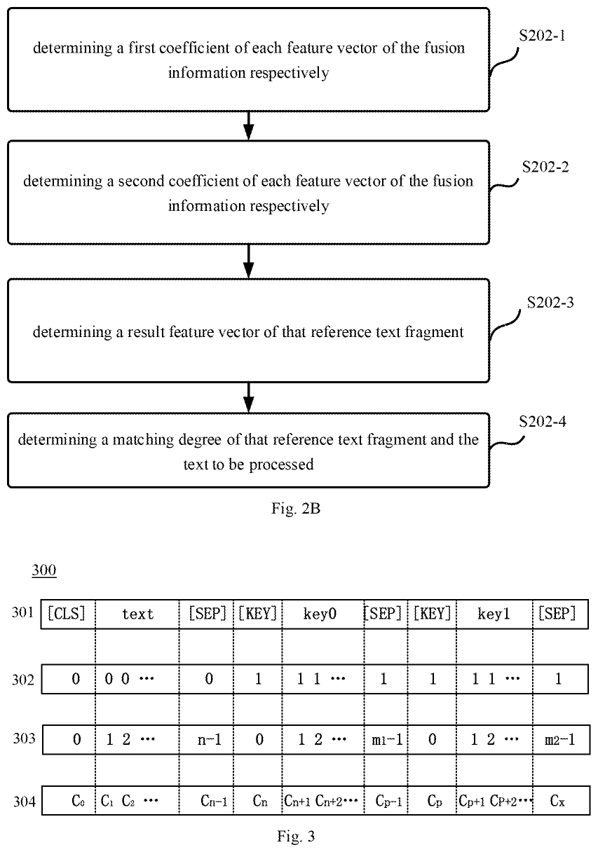

FIG. 2A and FIG. 2B show a data processing method according to an embodiment of the present disclosure. The method includes: step S201, fusion information is determined through a text to be processed and a plurality of reference text fragments, wherein the fusion information includes a feature vector of each character in the text to be processed, a feature vector of each character in each reference text fragment and a feature vector of an identifier of each reference text fragment; and step S202, a matching operation is executed for each of the plurality of reference text fragments. The matching operation includes: step S202-1, a first coefficient of each feature vector included in the fusion information is determined respectively based on the similarity between a feature vector of an identifier of the reference text fragment and each feature vector included in the fusion information; step S202-2, a second coefficient of each feature vector included in the fusion information is determined respectively based on the correlation between each feature vector included in the fusion information and other reference text fragments of the plurality of reference text fragments except the reference text fragment; step S202-3, a result feature vector of the reference text fragment is determined by using each feature vector included in the fusion information and a weight of the feature vector, wherein the weight of each feature vector is determined based on the first coefficient and the second coefficient of the feature vector; and step S202-4, a matching degree of the reference text fragment and the text to be processed is determined based on the result feature vector.

It is thus clear that in processing each reference text fragment in the present disclosure, apart from considering the similarity between the feature vectors in the fusion information, an influence degree on the result feature vector of the reference text fragment by the feature vectors from the other reference text fragments in the fusion information is regulated through the second coefficient, so in a process of executing matching of the text to be processed and the plurality of reference text fragments at the same time, each reference text fragment can obtain targeted processing, so that effective matching between the text to be processed and the plurality of reference text fragments can be executed at the same time, and the data processing efficiency is improved.

As for step S201, the text to be processed may be a sentence, a paragraph or a whole text. The plurality of reference text fragments may be preset or stored in a database and may represent key information of a text or may also be used for representing an attitude of a text author, etc.

According to some embodiments, the plurality of reference text fragments used for being subjected to a matching operation with the text to be processed are determined based on a classification result of the text to be processed. For example, the classification result of the text to be processed is a contract text, so it can be determined that the plurality of reference text fragments include “first party”, “second party”, “sum” and the like, which are used for determining key information in the text to be processed.

According to some embodiments, each character in the text to be processed and each character in each reference text fragment may be obtained after executing word segmentation based on a preset word list. The preset word list may be an ERNIE word list.

According to some embodiments, determining the fusion information through the text to be processed and the plurality of reference text fragments may include: at least based on a word vector of each character in the text to be processed, a feature vector of the character is determined; at least based on a word vector of each character in each reference text fragment, a feature vector of the character is determined; and at least based on a word vector of an identifier of each reference text fragment, a feature vector of the identifier is determined.

Each character or identifier solely corresponds to a word vector, so each character in the text to be processed, each character in each reference text fragment and an identifier of each reference text fragment are represented by the corresponding word vectors, different characters or identifiers can be effectively distinguished, and processing is convenient to perform through a machine model including a neural network.

According to some embodiments, the method may further include: a first identity vector corresponding to the text to be processed and a second identity vector corresponding to the plurality of reference text fragments are determined, wherein determining, at least based on the word vector of each character in the text to be processed, the feature vector of the character may include: the feature vector of the character is determined based on the word vector of each character in the text to be processed and the first identity vector; determining, at least based on the word vector of each character in each reference text fragment, the feature vector of the character may include: the feature vector of the character is determined based on the word vector of each character in each reference text fragment and the second identity vector; and determining, at least based on the word vector of the identifier of each reference text fragment, the feature vector of the identifier may include: the feature vector of the identifier is determined based on the word vector of the identifier of each reference text fragment and the second identity vector. Accordingly, the text to be processed and the reference text fragments can be effectively distinguished through the first identity vector and the second identity vector.

According to some embodiments, based on a weight sum of the word vector of each character in the text to be processed and the first identity vector, the feature vector of the character may be determined; based on a weight sum of the word vector of each character in each reference text fragment and the second identity vector, the feature vector of the character may be determined; and based on a weight sum of the word vector of the identifier of each reference text fragment and the second identity vector, the feature vector of the identifier may be determined.

According to some embodiments, the method may further include: a position vector of each character in the text to be processed is determined, wherein the position vector of each character in the text to be processed is different from one another; and for each of the plurality of reference text fragments, a position vector of each of each character in the reference text fragment and the identifier of the reference text fragment is determined, wherein the position vector of each of each character in the reference text fragment and the identifier of the reference text fragment is different from one another; wherein determining, at least based on the word vector of each character in the text to be processed, the feature vector of the character may include: the feature vector of the character is determined based on the word vector and the position vector of each character in the text to be processed; determining, at least based on the word vector of each character in each reference text fragment, the feature vector of the character may include: the feature vector of the character is determined based on the word vector and the position vector of each character in each reference text fragment; and determining, at least based on the word vector of the identifier of each reference text fragment, the feature vector of the identifier may include: the feature vector of the identifier is determined based on the word vector and the position vector of the identifier of each reference text fragment. In this way, a location of each character in the text to be processed or the reference text fragment can be distinguished through the position vector.

According to some embodiments, based on a weight sum of the word vector and the position vector of each character in the text to be processed, the feature vector of the character may be determined; based on a weight sum of the word vector and the position vector of each character in each reference text fragment, the feature vector of the character may be determined; and based on a weight sum of the word vector and the position vector of the identifier of each reference text fragment, the feature vector of the identifier may be determined.

According to some embodiments, based on a weight sum of the word vector of each character in the text to be processed, the first identity vector and the position vector, the feature vector of the character may be determined; based on a weight sum of the word vector of each character in each reference text fragment, the second identity vector and the position vector, the feature vector of the character may be determined; and based on a weight sum of the word vector of the identifier of each reference text fragment, the second identity vector and the position vector, the feature vector of the identifier may be determined.

FIG. 3 shows a schematic diagram of a method for determining fusion information according to an embodiment of the present disclosure. As shown in FIG. 3, a word vector matrix input^{token} may be obtained through the text to be processed and the plurality of reference text fragments, 301 is a schematic diagram of a word vector matrix input^{token}, the word vector matrix input^{token} is composed of word vectors corresponding to [CLS], text, [SEP], [KEY], key0 and key1 respectively, [CLS] is an initial identifier used for identifying a starting position, “text” represents a character string of the text to be processed, [SEP] is a separator used for separating the text to be processed and the reference text fragment, or used for separating two different reference text fragments, key0 and key1 represent character strings of different reference text fragments respectively, [KEY] in front of key0 represents an identifier of key0, and [KEY] in front of key1 represents an identifier of key1. In the word vector matrix input^{token}, each row represents a word vector corresponding to a symbol (including a character, an initial identifier, an identifier and a separator), a length of the word vector of each symbol is the same, and in a longitudinal direction of the word vector matrix input^{token} all the word vectors are arranged in sequence according to a sequence of symbols in 301.

A identity vector matrix input^{sent} may be obtained through the text to be processed and the plurality of reference text fragments, 302 is a schematic diagram of the identity vector matrix input^{sent}, where a identity vector corresponding to each symbol in a text to be processed unit [CLS]text[SEP] is a full-0 vector (namely, each element in the vector is 0), and an identity vector corresponding to each symbol in a reference text unit [KEY]key0[SEP] and [KEY]key1[SEP] is a full-1 vector (namely, each element in the vector is 1). In the identity vector matrix input^{sent}, each row represents a identity vector corresponding to a symbol (including a character, an initial identifier, an identifier and a separator), and a length of the identity vector of each symbol is equal to a length of its word vectors. In a longitudinal direction of the identity vector matrix input^{sent}, an arrangement sequence of the identity vectors of all the symbols is the same as the arrangement sequence of the word vectors of all the symbols in the longitudinal direction of the word vector matrix input^{token}.

A position vector matrix input^{pos} may be obtained through the text to be processed and the plurality of reference text fragments, 303 is a schematic diagram of the position vector matrix input^{pos}, where m1 is a quantity of symbols in a reference text unit [KEY]key0[SEP], m2 is a quantity of symbols in a reference text unit [KEY]key1[SEP], and as for each symbol in the text to be processed unit [CLS]text[SEP], a vector with the same element value is adopted as a position vector of the symbol respectively, where an element value of the position vector of each symbol is progressively increased in sequence according to a sequence of the symbol in the text to be processed unit. Therefore, [CLS] is represented by the full-0 vector, a first character in “text” is represented by the full-1 vector, a second character in “text” is represented by a full-2 vector, and so on, thus a position vector of each character in the unit can be determined. As for the reference text unit [KEY]key0[SEP] and the reference text unit [KEY]key1[SEP], a mode of determining the position vector of each symbol in each unit is the same as a mode of determining the position vector of each symbol in the text to be processed unit, which is not repeated herein. In the position vector matrix input^{pos}, each row represents a position vector corresponding to a symbol (including a character, an initial identifier, an identifier and a separator), and a length of the position vector of each symbol is equal to a length of its word vectors. In the longitudinal direction of the position vector matrix input^{pos}, an arrangement sequence of position vectors of all the symbols is the same as an arrangement sequence of the word vectors of all the symbols in the longitudinal direction of the word vector matrix input^{token}.

A result input^{embedding} of adding the above word vector matrix input^{token}, the identity vector matrix input^{sent} and the position vector matrix input^{pos} is used as the fusion information of the text to be processed and the plurality of reference text fragments, 304 is a schematic diagram of the fusion information input^{embedding} where p=n+m1, x=n+m1+m2−1. In the fusion information input^{embedding}, each row represents a feature vector (namely, C0 to Cx) corresponding to a symbol (including a character, an initial identifier, an identifier and a separator), and a length of the feature vector of each symbol is equal to a length of its word vectors. In a longitudinal direction of the fusion information input^{embedding}, an arrangement sequence of the feature vectors of all the symbols is the same as the arrangement sequence of the word vectors of all the symbols in the longitudinal direction of the word vector matrix input^{token}, that is:

[CLS]text[SEP][KEY]key0[SEP][KEY]key1[SEP].

It can be understood that in the embodiment shown in FIG. 3, the two reference text fragments are adopted only for convenient description, the quantity of adopted reference text fragments in a data processing process in the present disclosure may be any value greater than 2, which is not limited by the present disclosure.

As for step S202-1 in step S202, a first coefficient of each feature vector included in the fusion information is determined respectively based on the similarity between the feature vector of the identifier of the reference text fragment and each feature vector included in the fusion information.

Specifically, still taking the fusion information input^{embedding} in FIG. 3 as an example, through three different weights W_{Q}, W_{K} and W_{V} matrices, the fusion information input^{embedding} is subjected to linear mapping, so that three matrices Q, K and V can be obtained, which, specifically, may be represented by the following formula:

Q=Linear1(input^{embedding})=input^{embedding}W_{Q}

K=Linear2(input^{embedding})=input^{embedding}W_{K}

V=Linear3(input^{embedding})=input^{embedding}W_{V}

The matrix Q is multiplied by the matrix K, so that the similarity between any two feature vectors in the fusion information input^{embedding} can be obtained. A similarity matrix of the fusion information input^{embedding} may be represented as:

$$[ \begin{matrix}{C}_{0} {C}_{0} & {C}_{0} {C}_{1} & … & {C}_{0} {C}_{x} \\ {C}_{1} {C}_{0} & {C}_{1} {C}_{1} & … & {C}_{1} {C}_{x} \\ & ⋮ & & \\ {C}_{n - 1} {C}_{0} & {C}_{n - 1} {C}_{1} & … & {C}_{n - 1} {C}_{x} \\ {C}_{n} {C}_{0} & {C}_{n} {C}_{1} & … & {C}_{n} {C}_{x} \\ {C}_{n + 1} {C}_{0} & {C}_{n + 1} {C}_{1} & … & {C}_{n + 1} {C}_{x} \\ & ⋮ & & \\ {C}_{p - 1} {C}_{0} & {C}_{p - 1} {C}_{1} & … & {C}_{p - 1} {C}_{x} \\ {C}_{p} {C}_{0} & {C}_{p} {C}_{1} & … & {C}_{p} {C}_{x} \\ {C}_{p + 1} {C}_{0} & {C}_{p + 1} {C}_{1} & … & {C}_{p + 1} {C}_{x} \\ & ⋮ & & \\ {C}_{x} {C}_{0} & {C}_{x} {C}_{1} & … & {C}_{x} {C}_{x}\end{matrix} ]$$

where CᵢCⱼ represents the similarity between a feature vector Cᵢ and a feature vector Cⱼ in the fusion information input^{embedding}.

Taking a matching operation of the reference text fragment key0 as an example, the similarity between a feature vector Cₙ of an identifier of the reference text fragment key0 and each feature vector included in the fusion information input^{embedding} is CₙC₀, CₙC₁, CₙC₂ . . . CₙCₓ respectively, and according to the similarity between Cₙ and each feature vector, the first coefficient of each feature vector may be determined, for example, the first coefficient of each feature vector may be made to be CₙC₀, CₙC₁, CₙC₂ . . . CₙCₓ respectively.

As for step S202-2, according to some embodiments, determining the second coefficient of each feature vector included in the fusion information respectively based on the correlation between each feature vector included in the fusion information and other reference text fragments of the plurality of reference text fragments except the reference text fragment may include: each feature vector included in the fusion information is determined as one of a correlated feature vector or a non-correlated feature vector, wherein the correlated feature vector is a feature vector of a character or a feature vector of an identifier of any reference text fragment of the plurality of reference text fragments except the reference text fragment; and a second coefficient of the correlated feature vector is determined as a second coefficient smaller than the non-correlated feature vector.

By setting the second coefficient of any correlated feature vector to be smaller than the second coefficient of any non-correlated feature vector, the influence of the non-correlated feature vector can be reduced, and accuracy of a matching value calculated for each field can be guaranteed under the condition of simultaneously inputting the plurality of fields.

According to some embodiments, the second coefficient of any correlated feature vector is 0, and the second coefficient of any non-correlated feature vector is 1.

For example, still taking the matching operation for the reference text fragment key0 as an example, in the fusion information input^{embedding}, the feature vectors C₀ to Cₚ₋₁ are non-correlated feature vector, and the feature vectors Cₚ to Cₓ are correlated feature vectors. The second coefficients of the feature vectors C₀ to Cₚ₋₁ are set to be 1, and the second coefficients of the other feature vectors are set to be 0.

The second coefficient of each feature vector in the fusion information in the matching operation for each reference text fragment may be represented by the following matrix:

$$[ \begin{matrix}{a}_{0}^{0} & … & {a}_{t + {Σ l}_{i}}^{0} \\ ⋮ & ⋱ & ⋮ \\ {a}_{0}^{t + {Σ l}_{i}} & … & {a}_{t + {Σ l}_{i}}^{t + {Σ l}_{i}}\end{matrix} ]$$

where t is a symbol length of the text to be processed unit, li is a symbol length corresponding to an ith reference text fragment unit, aⱼ^{k} represents a second coefficient corresponding to a jth feature vector in the fusion information during executing of the matching operation in a unit where a kth feature vector in the fusion information is located. Specifically,

$${a}_{j}^{k} = \{ \begin{matrix}1 & if 0 \leq j \leq t \\ 1 & if t + \sum {l}_{i - 1} \leq k \leq t + \sum {l}_{i} and t + \sum {l}_{i - 1} \leq j \leq t + \sum {l}_{i} \\ 0 & else\end{matrix}$$

The above matrix is in the same dimension as the similarity matrix of the fusion information input^{embedding}, and a weight value during matching operation for each reference text fragment can be calculated by weighting and summation of the two matrices.

As for step S202-3, according to some embodiments, a sum of the first coefficient and the second coefficient of each feature vector may be determined as the weight of the feature vector.

The result feature vector of the reference text fragment may be determined according to each feature vector or a transformation vector (namely, each row in the matrix V) corresponding to each feature vector in the matrix V and a weight sum of the weight of the feature vector.

According to some embodiments, the feature vector of each character in the text to be processed, the feature vector of each character in each reference text fragment and the feature vector of the identifier of each reference text fragment included in the fusion information are connected in sequence, and determining each feature vector included in the fusion information as one of the correlated feature vector or the non-correlated feature vector may include: the feature vector is determined as one of the correlated feature vector or the non-correlated feature vector according to a location, in the fusion information, of each feature vector included in the fusion information.

Therefore, the correlation between the feature vector and the specific reference text fragment can be conveniently determined according to a preset sequence in the fusion information.

According to some embodiments, the method further includes: a reference text fragment corresponding to the text to be processed is determined among the plurality of reference text fragments based on a matching degree of each of the plurality of reference text fragments. Therefore, callback processing may be further executed based on the matching degree of each determined reference text fragment.

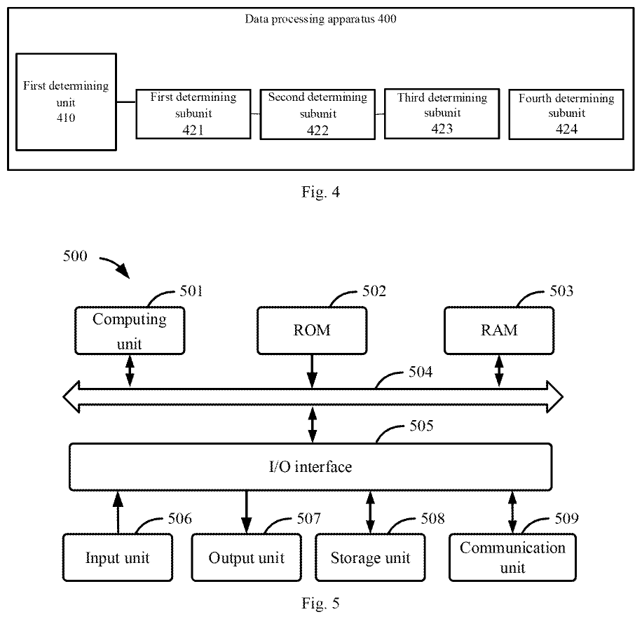

FIG. 4 shows an apparatus for data processing according to an embodiment of the present disclosure. As shown in FIG. 4, the apparatus 400 includes: a first determining unit 410, configured to determine fusion information through a text to be processed and a plurality of reference text fragments, wherein the fusion information includes a feature vector of each character in the text to be processed, a feature vector of each character in each reference text fragment and a feature vector of an identifier of each reference text fragment; and a matching unit 420, configured to execute a matching operation for each of the plurality of reference text fragments, wherein the matching unit 420 includes: a first determining subunit 421, configured to determine a first coefficient of each feature vector included in the fusion information respectively based on the similarity between a feature vector of an identifier of the reference text fragment and each feature vector included in the fusion information; a second determining subunit 422, configured to determine a second coefficient of each feature vector included in the fusion information respectively based on the correlation between each feature vector included in the fusion information and other reference text fragments of the plurality of reference text fragments except the reference text fragment; a third determining subunit 423, configured to determine a result feature vector of the reference text fragment by using each feature vector included in the fusion information and a weight of the feature vector, wherein the weight of each feature vector is determined based on the first coefficient and the second coefficient of the feature vector; and a fourth determining subunit 424, configured to determine a matching degree of the reference text fragment and the text to be processed based on the result feature vector.

According to some embodiments, the second determining subunit includes: a fifth determining subunit, configured to determine each feature vector included in the fusion information as one of a correlated feature vector or a non-correlated feature vector, wherein the correlated feature vector is a feature vector of a character or a feature vector of an identifier of any reference text fragment of the plurality of reference text fragments except the reference text fragment; and a sixth determining subunit, configured to determine a second coefficient of the correlated feature vector to be smaller than a second coefficient of the non-correlated feature vector.

According to some embodiments, the second coefficient of any correlated feature vector is 0, and the second coefficient of any non-correlated feature vector is 1.

According to some embodiments, the feature vector of each character in the text to be processed, the feature vector of each character in each reference text fragment and the feature vector of the identifier of each reference text fragment included in the fusion information are connected in sequence. The fifth determining subunit includes: a subunit, configured to determine the feature vector as one of the correlated feature vector or the non-correlated feature vector according to a location, in the fusion information, of each feature vector included in the fusion information.

According to some embodiments, the first determining unit includes: a seventh determining subunit, configured to determine, at least based on a word vector of each character in the text to be processed, a feature vector of the character; an eighth determining subunit, configured to determine, at least based on a word vector of each character in each reference text fragment, a feature vector of the character; and a ninth determining subunit, configured to determine, at least based on a word vector of an identifier of each reference text fragment, a feature vector of the identifier.

According to some embodiments, the first determining unit further includes: a tenth determining subunit, configured to determine a first identity vector corresponding to the text to be processed and a second identity vector corresponding to the plurality of reference text fragments. The seventh determining subunit includes: a subunit, configured to determine the feature vector of the character based on the word vector of each character in the text to be processed and the first identity vector. The eighth determining subunit includes: a subunit, configured to determine the feature vector of the character based on the word vector of each character in each reference text fragment and the second identity vector. The ninth determining subunit includes: a subunit, configured to determine the feature vector of the identifier based on the word vector of the identifier of each reference text fragment and the second identity vector.

According to some embodiments, the first determining unit further includes: an eleventh determining subunit, configured to determine a position vector of each character in the text to be processed, wherein the position vector of each character in the text to be processed is different from one another; and a twelfth determining subunit, configured to determine, for each of the plurality of reference text fragments, a position vector of each of each character in the reference text fragment and the identifier of the reference text fragment, wherein the position vector of each of each character in the reference text fragment and the identifier of the reference text fragment is different from one another. The seventh determining subunit includes: a subunit, configured to determine the feature vector of the character based on the word vector and the position vector of each character in the text to be processed. The eighth determining subunit includes: a subunit, configured to determine the feature vector of the character based on the word vector and the position vector of each character in each reference text fragment. The ninth determining subunit includes: a subunit, configured to determine the feature vector of the identifier based on the word vector and the position vector of the identifier of each reference text fragment.

According to some embodiments, a second determining unit is configured to determine a reference text fragment corresponding to the text to be processed among the plurality of reference text fragments based on a matching degree of each of the plurality of reference text fragments.

According to an embodiment of the present disclosure, an electronic device is further provided and includes: at least one processor; and a memory in communication connection with the at least one processor, wherein the memory stores an instruction that can be executed by the at least one processor, and the instruction is executed by the at least one processor, such that the at least one processor executes any above method.

According to an embodiment of the present disclosure, a non-transitory computer-readable storage medium storing a computer instruction is further provided, wherein the computer instruction is used for enabling a computer to execute any above method.

According to an embodiment of the present disclosure, a computer program product is further provided and includes a computer program, wherein the computer program, when executed by a processor, implements any above method.

Referring to FIG. 5, a structural block diagram of an electronic device 500 capable of serving as a server or a client of the present disclosure is described now, which is an example of a hardware device applicable to various aspects of the present disclosure. The electronic device intends to represent various digital electronic computer devices, such as a laptop computer, a desktop computer, a workbench, a personal digital assistant, a server, a blade server, a mainframe computer and other suitable computers. The electronic device may also represent various mobile apparatuses, such as a personal assistant, a cell phone, a smartphone, a wearable device and other similar computing apparatuses Components shown herein, their connections and correlations and their functions are only examples and do not intend to limit implementation of the present disclosure described herein.

As shown in FIG. 5, the electronic device 500 includes a computing unit 501, which can execute various appropriate actions and processing according to a computer program stored in a read-only memory (ROM) 502 or a computer program loaded from a storage unit 508 to a random access memory (RAM) 503. The RAM 503 can also store various programs and data needed by operations of the electronic device 500. The computing unit 501, the ROM 502 and the RAM 503 are mutually connected through a bus 504. An input/output (I/O) interface 505 is also connected to the bus 504.

A plurality of components in the electronic device 500 are connected to the I/O interface 505, including: an input unit 506, an output unit 507, the storage unit 508, and a communication unit 509. The input unit 506 may be any type of devices capable of inputting information to the electronic device 500, can receive input number or character information and generate key signal input related to user setting and/or function control of the electronic device and can include but not limited to a mouse, a keyboard, a touch screen, a trackpad, a trackball, a joystick, a microphone and/or a remote-control unit. The output unit 507 may be any type of device capable of displaying information and may include but not limited to a display, a speaker, a video/audio output terminal, a vibrator and/or a printer. The storage unit 508 may include but not limited to a magnetic disk and a compact disc. The communication unit 509 may allow the electronic device 500 to exchange information/data with other devices through a computer network, such as Internet, and/or various telecommunication networks and may include but not limited to a modem, a network card, an infrared communication device, a wireless communication transceiver and/or a chipset, for example, a Bluetooth™ device, a 802.11 device, a WiFi device, a WiMax device, a cellular communication device and/or similar items.

The computing unit 501 may be various general-purpose and/or special-purpose processing components with processing and computing capacity. Some examples of the computing unit 501 include but not limited to a central processing unit (CPU), a graphics processing unit (GPU), various special-purpose artificial intelligence (AI) computing chips, various computing units for running a machine learning model algorithm, a digital signal processor (DSP), and any appropriate processor, controller, microcontroller and the like. The computing unit 501 executes each method and processing described above, for example, the method for data processing. For example, in some embodiments, the method for data processing may be realized as a computer software program, which is tangibly contained in a machine-readable medium, for example, the storage unit 508. In some embodiments, a part of or all the computer program may be loaded into and/or installed onto the electronic device 500 via the ROM 502 and/or the communication unit 509. When the computer program is loaded to the RAM 503 and executed by the computing unit 501, one or more steps of the method for data processing described above can be executed. Alternatively and additionally, in other embodiments, the computing unit 501 may be configured to execute the method for data processing in any other appropriate mode (for example, by means of firmware).

Various implementations of the systems and technologies described above in this paper may be implemented in a digital electronic circuit system, an integrated circuit system, a field programmable gate array (FPGA), an application specific integrated circuit (ASIC), an application specific standard part (ASSP), a system on chip (SOC), a complex programmable logic device (CPLD), computer hardware, firmware, software and/or their combinations. These various implementations may include: being implemented in one or more computer programs, wherein the one or more computer programs may be executed and/or interpreted on a programmable system including at least one programmable processor, and the programmable processor may be a special-purpose or general-purpose programmable processor, and may receive data and instructions from a storage system, at least one input apparatus, and at least one output apparatus, and transmit the data and the instructions to the storage system, the at least one input apparatus, and the at least one output apparatus.

Program codes for implementing the methods of the present disclosure may be written in any combination of one or more programming languages. These program codes may be provided to processors or controllers of a general-purpose computer, a special-purpose computer or other programmable data processing apparatuses, so that when executed by the processors or controllers, the program codes enable the functions/operations specified in the flow diagrams and/or block diagrams to be implemented. The program codes may be executed completely on a machine, partially on the machine, partially on the machine and partially on a remote machine as a separate software package, or completely on the remote machine or server.

In the context of the present disclosure, a machine readable medium may be a tangible medium that may contain or store a program for use by or in connection with an instruction execution system, apparatus or device. The machine readable medium may be a machine readable signal medium or a machine readable storage medium. The machine readable medium may include but not limited to an electronic, magnetic, optical, electromagnetic, infrared, or semiconductor system, apparatus or device, or any suitable combination of the above contents. More specific examples of the machine readable storage medium will include electrical connections based on one or more lines, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above contents.

In order to provide interactions with users, the systems and techniques described herein may be implemented on a computer, and the computer has: a display apparatus for displaying information to the users (e.g., a CRT (cathode ray tube) or LCD (liquid crystal display) monitor); and a keyboard and a pointing device (e.g., a mouse or trackball), through which the users may provide input to the computer. Other types of apparatuses may further be used to provide interactions with users; for example, feedback provided to the users may be any form of sensory feedback (e.g., visual feedback, auditory feedback, or tactile feedback); an input from the users may be received in any form (including acoustic input, voice input or tactile input).

The systems and techniques described herein may be implemented in a computing system including background components (e.g., as a data server), or a computing system including middleware components (e.g., an application server) or a computing system including front-end components (e.g., a user computer with a graphical user interface or a web browser through which a user may interact with the implementations of the systems and technologies described herein), or a computing system including any combination of such background components, middleware components, or front-end components. The components of the system may be interconnected by digital data communication (e.g., a communication network) in any form or medium. Examples of the communication network include: a local area network (LAN), a wide area network (WAN) and the Internet.

A computer system may include a client and a server. The client and the server are generally away from each other and usually interact through a communication network. The correlation between the client and the server is generated by running a computer program with a mutual client-server correlation on a corresponding computer. The server may be a cloud server, or may be a server of a distributed system, or a server combined with a blockchain.

It should be understood that steps can be reranked, added or deleted by using various forms of flows shown above. For example, all the steps recorded in the present disclosure can be executed in parallel, or in sequence or in different orders, which is not limited herein as long as a desired result of the technical solutions disclosed by the present disclosure can be realized.

Though the embodiments or the examples of the present disclosure are already described with reference to the drawings, it should be understood that the above method, system or device is only an example embodiment or example, and the scope of present disclosure is not limited by these embodiments or examples. Various elements in the embodiments or the examples may be omitted or replaced by their equivalent elements. Besides, all the steps may be executed in sequence different from a sequence described in the present disclosure. Furthermore, various elements in the embodiments or the examples may be combined in various modes. What counts is that with technology evolution, many elements described here can be replaced by equivalent elements appearing after the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A data processing method, comprising:
determining fusion information based on a text to be processed and a plurality of reference text fragments, wherein the fusion information comprises a feature vector of each character in the text to be processed, a feature vector of each character in each reference text fragment of the plurality of reference text fragments and a feature vector of an identifier of each reference text fragment; and
executing a matching operation for each reference text fragment, wherein the matching operation comprises:
determining a first coefficient of each feature vector of the fusion information, respectively, based on a similarity between the feature vector of the identifier of the reference text fragment and each feature vector of the fusion information;
determining a second coefficient of each feature vector of the fusion information, respectively, based on a correlation between each feature vector of the fusion information and each of one or more remaining reference text fragments other than the reference text fragment of the plurality of reference text fragments;
determining a result feature vector of the reference text fragment based on each feature vector of the fusion information and a weight corresponding to the feature vector, wherein the weight corresponding to the feature vector is determined based on the first coefficient and the second coefficient of the feature vector; and
determining a matching degree of the reference text fragment and the text to be processed based on the result feature vector.

2. The method according to claim 1, wherein the determining the second coefficient of each feature vector of the fusion information, respectively, based on the correlation between each feature vector of the fusion information and each of the one or more remaining text fragments other than the reference text fragment of the plurality of reference text fragments comprises:
determining each feature vector of the fusion information as a correlated feature vector or a non-correlated feature vector, wherein the correlated feature vector is the feature vector of the character in a remaining text fragment or a feature vector of an identifier of a remaining text fragment other than the reference text fragment of the plurality of reference text fragments; and
determining the second coefficient of the correlated feature vector to be smaller than the second coefficient of the non-correlated feature vector.

3. The method according to claim 2, wherein the second coefficient of each correlated feature vector is 0, and the second coefficient of each non-correlated feature vector is 1.

4. The method according to claim 2, wherein the feature vector of each character in the text to be processed, the feature vector of each character in each reference text fragment and the feature vector of the identifier of each reference text fragment comprised in the fusion information are connected in sequence, and
wherein the determining each feature vector of the fusion information as the correlated feature vector or the non-correlated feature vector comprises:
determining the feature vector as the correlated feature vector or the non-correlated feature vector based on a position, in the fusion information, of each feature vector of the fusion information.

5. The method according to claim 1, wherein the determining the fusion information based on the text to be processed and the plurality of reference text fragments comprises:
determining, based on a word vector of each character in the text to be processed, the feature vector of the character in the text to be processed;
determining, based on the word vector of each character in each reference text fragment, the feature vector of the character in the reference text fragment; and
determining, based on the word vector of the identifier of each reference text fragment, the feature vector of the identifier.

6. The method according to claim 5, further comprising:
determining a first identity vector corresponding to the text to be processed and a second identity vector corresponding to the plurality of reference text fragments,
wherein the determining, based on the word vector of each character of the text to be processed, the feature vector of the character comprises: determining the feature vector of the character based on the word vector of each character of the text to be processed and the first identity vector;
wherein the determining, based on the word vector of each character of each reference text fragment, the feature vector of the character comprises: determining the feature vector of the character based on the word vector of each character in each reference text fragment and the second identity vector; and
wherein the determining, based on the word vector of the identifier of each reference text fragment, the feature vector of the identifier comprises: determining the feature vector of the identifier based on the word vector of the identifier of each reference text fragment and the second identity vector.

7. The method according to claim 5, further comprising:
determining a position vector of each character in the text to be processed, wherein position vectors of characters in the text to be processed are different from one another; and
determining, for each reference text fragment of the plurality of reference text fragments, a position vector of each symbol of the reference text fragment, wherein the symbol comprises the character and the identifier, and wherein position vectors of symbols of the reference text fragment are different from one another;
wherein the determining, based on the word vector of each character in the text to be processed, the feature vector of the character comprises: determining, based on the word vector and the position vector of each character in the text to be processed, the feature vector of the character;
wherein the determining, based on the word vector of each character in each reference text fragment, the feature vector of the character comprises: determining, based on the word vector and the position vector of each character in each reference text fragment, the feature vector of the character; and
wherein the determining, based on the word vector of the identifier of each reference text fragment, the feature vector of the identifier comprises: determining, based on the word vector and the position vector of the identifier of each reference text fragment, the feature vector of that identifier.

8. The method according to claim 1, further comprising:
determining a reference text fragment corresponding to the text to be processed among the plurality of reference text fragments based on the matching degree corresponding to each reference text fragment of the plurality of reference text fragments.

9. An electronic device, comprising:
one or more processors; and
a memory storing one or more programs configured to be executed by the one or more processors, the one or more programs comprising instructions for performing operations comprising:
determining fusion information based on a text to be processed and a plurality of reference text fragments, wherein the fusion information comprises a feature vector of each character in the text to be processed, a feature vector of each character in each reference text fragment of the plurality of reference text fragments and a feature vector of an identifier of each reference text fragment; and
executing a matching operation for each reference text fragment, wherein the matching operation comprises:
determining a first coefficient of each feature vector of the fusion information, respectively, based on a similarity between the feature vector of the identifier of the reference text fragment and each feature vector of the fusion information;
determining a second coefficient of each feature vector of the fusion information, respectively, based on a correlation between each feature vector of the fusion information and each of one or more remaining reference text fragments other than the reference text fragment of the plurality of reference text fragments;
determining a result feature vector of the reference text fragment based on each feature vector of the fusion information and a weight corresponding to the feature vector, wherein the weight corresponding to the feature vector is determined based on the first coefficient and the second coefficient of the feature vector; and
determining a matching degree of the reference text fragment and the text to be processed based on the result feature vector.

10. The electronic device according to claim 9, wherein the determining the second coefficient of each feature vector of the fusion information, respectively, based on the correlation between each feature vector of the fusion information and each of the one or more remaining text fragments other than the reference text fragment of the plurality of reference text fragments comprises:
determining each feature vector of the fusion information as a correlated feature vector or a non-correlated feature vector, wherein the correlated feature vector is the feature vector of the character in a remaining text fragment or the feature vector of an identifier of a remaining text fragment other than the reference text fragment of the plurality of reference text fragments; and
determining the second coefficient of the correlated feature vector to be smaller than the second coefficient of the non-correlated feature vector.

11. The electronic device according to claim 10, wherein the second coefficient of each correlated feature vector is 0, and the second coefficient of each non-correlated feature vector is 1.

12. The electronic device according to claim 10, wherein the feature vector of each character in the text to be processed, the feature vector of each character in each reference text fragment and the feature vector of the identifier of each reference text fragment comprised in the fusion information are connected in sequence, and
wherein the determining each feature vector of the fusion information as the correlated feature vector or the non-correlated feature vector comprises:
determining the feature vector as the correlated feature vector or the non-correlated feature vector based on a position, in the fusion information, of each feature vector of the fusion information.

13. The electronic device according to claim 9, wherein the determining the fusion information based on the text to be processed and the plurality of reference text fragments comprises:
determining, based on a word vector of each character in the text to be processed, the feature vector of the character in the text to be processed;
determining, based on the word vector of each character in each reference text fragment, the feature vector of the character in the reference text fragment; and
determining, based on the word vector of the identifier of each reference text fragment, the feature vector of the identifier.

14. The electronic device according to claim 13, the performing operations further comprising:
determining a first identity vector corresponding to the text to be processed and a second identity vector corresponding to the plurality of reference text fragments,
wherein the determining, based on the word vector of each character of the text to be processed, the feature vector of the character comprises: determining the feature vector of the character based on the word vector of each character of the text to be processed and the first identity vector;
wherein the determining, based on the word vector of each character of each reference text fragment, the feature vector of the character comprises: determining the feature vector of the character based on the word vector of each character in each reference text fragment and the second identity vector; and
wherein the determining, based on the word vector of the identifier of each reference text fragment, the feature vector of the identifier comprises: determining the feature vector of the identifier based on the word vector of the identifier of each reference text fragment and the second identity vector.

15. The electronic device according to claim 13, the performing operations further comprising:
determining a position vector of each character in the text to be processed, wherein position vectors of characters in the text to be processed are different from one another; and
determining, for each reference text fragment of the plurality of reference text fragments, a position vector of each symbol of the reference text fragment, wherein the symbol comprises the character and the identifier, and wherein position vectors of each symbols of the reference text fragment are different from one another;
wherein the determining, based on the word vector of each character in the text to be processed, the feature vector of the character comprises: determining, based on the word vector and the position vector of each character in the text to be processed, the feature vector of the character;
wherein the determining, based on the word vector of each character in each reference text fragment, the feature vector of the character comprises: determining, based on the word vector and the position vector of each character in each reference text fragment, the feature vector of the character; and
wherein the determining, based on the word vector of the identifier of each reference text fragment, the feature vector of the identifier comprises: determining, based on the word vector and the position vector of the identifier of each reference text fragment, the feature vector of that identifier.

16. The electronic device according to claim 9, the performing operations further comprising:
determining a reference text fragment corresponding to the text to be processed among the plurality of reference text fragments based on the matching degree corresponding to each reference text fragment of the plurality of reference text fragments.

17. A non-transitory computer readable storage medium storing one or more programs comprising instructions that, when executed by one or more processors of an electronic device, cause the electronic device to perform operations comprising:
determining fusion information based on a text to be processed and a plurality of reference text fragments, wherein the fusion information comprises a feature vector of each character in the text to be processed, a feature vector of each character in each reference text fragment of the plurality of reference text fragments and a feature vector of an identifier of each reference text fragment; and
executing a matching operation for each reference text fragment, wherein the matching operation comprises:
determining a first coefficient of each feature vector of the fusion information, respectively, based on a similarity between the feature vector of the identifier of the reference text fragment and each feature vector of the fusion information;
determining a second coefficient of each feature vector of the fusion information, respectively, based on a correlation between each feature vector of the fusion information and each of one or more remaining reference text fragments other than the reference text fragment of the plurality of reference text fragments;
determining a result feature vector of the reference text fragment based on each feature vector of the fusion information and a weight corresponding to the feature vector, wherein the weight corresponding to the feature vector is determined based on the first coefficient and the second coefficient of the feature vector; and
determining a matching degree of the reference text fragment and the text to be processed based on the result feature vector.

18. The computer readable storage medium of claim 17, wherein the determining the second coefficient of each feature vector of the fusion information, respectively, based on the correlation between each feature vector of the fusion information and each of the one or more remaining text fragments other than the reference text fragment of the plurality of reference text fragments comprises:
determining each feature vector of the fusion information as a correlated feature vector or a non-correlated feature vector, wherein the correlated feature vector is the feature vector of the character in a remaining text fragment or the feature vector of an identifier of a remaining text fragment other than the reference text fragment of the plurality of reference text fragments; and
determining the second coefficient of the correlated feature vector to be smaller than the second coefficient of the non-correlated feature vector.

19. The computer readable storage medium of claim 18, wherein the second coefficient of each correlated feature vector is 0, and the second coefficient of each non-correlated feature vector is 1.

20. The computer readable storage medium of claim 18, wherein the feature vector of each character in the text to be processed, the feature vector of each character in each reference text fragment and the feature vector of the identifier of each reference text fragment comprised in the fusion information are connected in sequence, and
wherein the determining each feature vector of the fusion information as the correlated feature vector or the non-correlated feature vector comprises:
determining the feature vector as the correlated feature vector or the non-correlated feature vector based on a position, in the fusion information, of each feature vector of the fusion information.
